(19) United States
(12) Patent Application Publication
(10) Pub. No.: US 2023/0085926 A1
(43) Pub. Date: Mar. 23, 2023

(54) PRIMER FOR PRODUCING A PARTABLE ADHESIVE BOND

(71) Applicant: tesa SE, Norderstedt (DE)

(72) Inventors: Felix Budde, Hamburg (DE); Klaus Keite-Telgenbüscher, Hamburg (DE); Lena Claussen, Norderstedt (DE); Claudia Moehrke, Hamburg (DE); Shuang Wang, Hamburg (DE)

(73) Assignee: tesa SE, Norderstedt (DE)

(21) Appl. No.: 17/949,641

(22) Filed: Sep. 21, 2022

(30) Foreign Application Priority Data
Sep. 22, 2021 (DE) 10 2021 210 563.7

(51) Int. Cl. C09J 7/38; C09J 7/26

(52) U.S. Cl. CPC C09J 7/385; C09J 7/26

(57) ABSTRACT

Primer for producing a partable adhesive bond, the primer being based on a pressure-sensitive adhesive which comprises a chemical or physical blowing agent.

The present invention relates to a primer for producing a partable adhesive bond and also to a partable layered structure designed and equipped to be separated after long-term bonding. The present invention further encompasses a method for parting a long-term bond produced by means of a layered structure of this kind.

In repair shops and in the end-of-life recycling of electronic devices, the desire to repair electronic devices or else motor vehicles or to be able to extensively as possible to disassemble and/or recycle them is gaining in importance for not just environmental reasons but also economic reasons.

Here there are different kinds of electronic devices, differing their recyclability and also in the degree of recycling:
Large household appliances (also called white goods): for example washing machines, refrigerators and freezers, ovens;
Small household appliances (likewise included in white goods): for example vacuum cleaners, coffee machines, microwaves;
Information technology and communication devices, for example computers, monitors, printers, mobiles, telephones;
Consumer electronic devices (also called brown goods): for example televisions, video recorders, digital cameras.

Particularly, electrical and electronic devices contain a multiplicity of substances and materials. If used electrical and electronic devices are disposed of improperly, such as via the household waste, for example, environmental risks may arise from the pollutants they still contain in some cases. As well as pollutants such as heavy metals and HCFCs, however, used electrical and electronic devices also contain a range of value substances, which should be recovered and therefore recirculated. Where, conversely, used electrical and electronic devices are disposed of properly, it is possible to replace primary raw materials (and hence their costly and laborious extraction) and to make a substantial contribution to the preservation of natural resources.

In order to be able to achieve these objectives, there are specific obligations imposed on all relevant actors (manufacturers, trade, municipalities, owners, waste managers) in Germany by the law governing the sale, return and environmentally sound disposal of electrical and electronic equipment (Electrical and Electronic Equipment Law—ElektroG) in implementation of Directive 2012/19/EU concerning waste electrical and electronic equipment (WEEE). By avoiding waste, through reasonable tests for possibilities of preparation for the re-use of entire devices or individual components, and by requirements regarding the more extensive recovery of value from wastes, the aim is to achieve a substantial contribution to preserving natural resources and to reducing pollutant emissions.

Corresponding recycling-friendly designs are needed which enable on-demand disassembly (debonding on demand). Among the recycling-friendly designs are repartable adhesive bonds, since in small electronic devices in particular there is very sharply increasing trend towards adhesively bonding parts, usually on a long-term basis, rather than connecting them in a way which can be undone mechanically.

EP 1 814 935 A1 describes a method for assembling two substrates by means of adhesive bonding with at least one sealing joint which consists of a polymer material and a migrating agent, the latter being capable of migrating to the interface in order to form a layer with weak cohesion.

It additionally describes a method for parting the bond previously produced, by supplying energy to the sealing joint and/or to the migrating agent. The migrating agent migrates to the interface and produces a site of weak cohesion, thereby enabling the separation of the substrates.

No primer is disclosed. The medium is an adhesive which comprises a migrating agent that migrates to the interface. A pressure-sensitive adhesive tape is not disclosed.

WO 00/75254 A1 relates to a composition, its use, and a method of using it as a glazing adhesive. The composition comprises an adhesive incorporating dispersed thermoexpandable microcapsules, which act as pressure triggers. The microcapsules are triggered by heat, to release at least one expandable volatile active ingredient which is encapsulated in the microcapsule shell.

EP 2 265 681 A1 describes a composition for parting an adhesive bond between two substrates. The composition consists of an adhesive base polymer and an active ingredient intended for parting the assembly. The active ingredient is encapsulated in wax.

The encapsulation comprises a microencapsulation, thermal gelling or other stated methods.

WO 2005/028583 A1 relates to a destructuring agent (3 to 40 wt %) for an adhesive composition. The polymer base comprises epoxy, acrylic or urethane species. The destructuring agents are heat-activatable and come from the family of the hydrazides (especially pTSH) and particularly the sulfohydrazides.

Used additionally is an activator (1 to 5 wt %) from the family of the carbamides (especially urea). Mention is also made of the relationship between viscosity and target layer thickness.

Known from EP 1 111 020 A1 are adhesive compositions for partable adhesive bonds, these compositions containing thermally activatable debonding substances that are solid at room temperature.

The additional of thermally activatable substances from the group of dicarboxylic acids, azo compounds, carbonates, substances containing water of crystallization, and polyalcohols to commercially customary adhesives enables thermal splitting of the adhesive bond. In this way a bond can be easily parted again by heat, so facilitating the recycling of the bonded components.

EP 1 611 217 A1 describes a method for assembling two substrates by adhesion with a bond. This is done by applying an adhesion primer to one substrate, for controlled removal. This primer consists of a polymer base and an agent for degradation of the bond. The adhesive bond is parted by supplying energy, so that the degradation agent degrades the bond between primer and substrate or the mass.

The primer may be in diluted form, for the application of particularly thin layers. The primer consists of polymer base or a wax and a degradation agent. The degradation agent is pTSH. The sole polymer base disclosed for the primer is epoxy resin. Toluene is solvent.

FR 2837114 A1 describes a process (consisting of five phases) for parting a coating which comprises an additive, by supplying thermal or electromagnetic energy.

The five phases are:
Phase 1 (formulating)—additive and adhesive
Phase 2 (conditioning)
Phase 3 (implementing the formulation)—production of bond
Phase 4 (operating phase)
Phase 5 (controlled separating phase)

EP 2 519 596 A1 disclosed a method for disintegrating an assembly consisting of two substrates bonded adhesively by a bonding layer. The polymer material for the bonding layer consists of polyurethane or silicone and comprises a migrating agent which migrates to one of the interfaces and causes the detachment of one interface by exposure to heat. Heating must be carried out to the activation temperature of the migrating agent. The detachment is brought about by the gas that is generated.

WO 2021/028457 A1 describes a removable composition composed of a polyamide or of a mixture of polyamides that is or are soluble in alcohol, and of an expandable additive having an expansion temperature higher than the melting point of the polyamide.

The alcohol is selected from light aliphatic alcohols or benzyl alcohol.

The polyamide dissoluble in alcohol is a copolyamide.

The expandable additive may be temperature-activatable expandable microspheres, azodicarbonamides, expandable graphite, polycarboxylic acids and sulfonylhydrazides

The proportions of polymer and additive are described.

The specification describes a primer which is foamable by microballoons for the easy removal of unwanted paint. The base consists of an acrylate resin or polyvinylacetate. The substances are thermally expandable by temperature.

An object of the present invention, therefore, is to provide a primer for a layered structure that on the one hand enables long-term and reliable bonding of a component with an adhesive tape, but on the other hand, as and when required, enables clean and reliable separation of the adhesive tape from the component.

The object is achieved in accordance with the invention by a primer as described in Claim 1. Advantageous embodiments of the primer are set out in the dependent claims. The solution provided by the invention further includes a layered structure with the primer and also a method for parting the layered structure.

The present invention relates accordingly to a primer for producing a partable adhesive bond, the primer being based on a pressure-sensitive adhesive which comprises a chemical or physical blowing agent.

In the sense of the invention the term “primer” denotes a ground coat which is applied to a substrate and is capable (either on a chemical or a physical basis) of interacting with two layers of materials and enabling their adhesion. In other words, not substantially to detract from, but not necessarily to improve, the adhesion without the use of a primer. Not substantially to detract from means that the peel adhesion of two layers of materials to one another with primer is not less than 75% of the peel adhesion of the layers of material to one another without primer.

The primer is considered generally as a formulated product (which generally contains more than one component) and which is applied from the liquid phase by a particular method (immersion into the surface, spreading, spraying, etc.). According to this definition, the primer ought to have the capacity not only to enable adhesion but also to form a uniform priming coat on the surface of the substrate, by adaptation to its viscosity, its wetting properties, its drying rate, etc.

In the invention the primer is formulated on the basis of a pressure-sensitive adhesive and comprises a chemical or physical blowing agent which after activation enables the parting of the adhesive bond.

“Based on” or “on the basis of” means in the present context that the properties of the primer are determined by the pressure-sensitive adhesive. In other words, the base polymer of the primer has a certain touch-stickiness.

A “pressure-sensitive adhesive” (PSA) is understood in the invention, as generally customary, to be a substance which—in particular at room temperature—is permanently tacky and also adhesive. A PSA, characteristically, can be applied by pressure to a substrate and remains adhering there, with no further definition of the pressure to be applied or the period of exposure to this pressure. In certain cases, depending on the precise nature of the PSA, the temperature and the atmospheric humidity, and also the substrate, the influence of a brief, minimal pressure, which does not go beyond gentle contact for a short moment, is enough to achieve the adhesion effect, while in other cases a longer-term period of exposure to a high pressure may be necessary.

PSAs have particular, characteristic viscoelastic properties which result in permanent tack and adhesiveness. A feature of these adhesives is that when they are mechanically deformed, there are processes of viscous flow and there is also development of elastic forces of recovery. The two processes have a certain relationship to one another in terms of their respective proportion, depending not only on the precise composition, the structure and the degree of crosslinking of the PSA but also on the rate and duration of the deformation, and on the temperature.

The proportional viscous flow is necessary for the achievement of adhesion. Only the viscous components, brought about by macromolecules with relatively high mobility, permit effective wetting and effective adaptation to the substrate to be bonded. A high viscous flow component results in high touch-stickiness (also referred to as tack or surface stickiness) and hence often also to high peel adhesion. Highly crosslinked systems, crystalline polymers or polymers with glass-like solidification lack flowable components and are in general devoid of or at least possess only little tack.

The proportional elastic forces of recovery are necessary for the achievement of cohesion. They are brought about, for example, by very long-chain macromolecules with a high degree of entanglement, and also by physically or chemically crosslinked macromolecules, and they enable the transmission of the forces that act on an adhesive bond. As a result of these forces of recovery, an adhesive bond is able to withstand a long-term load acting on it, in the form of a sustained shearing load, for example, to a sufficient degree over a relatively long time period.

For more precise description and quantification of the extent of elastic and viscous components, and also of the relationship between the components, the variables of storage modulus (G′) and loss modulus (G″) can be employed, and are determinable by means of dynamic mechanical analysis (DMA). G′ is a measure of the elastic component, G″ a measure of the viscous component, of a substance. Both variables are dependent on the deformation frequency and the temperature.

The variables can be determined using a rheometer. In that case, for example, the material under investigation is exposed in a plate/plate arrangement to a sinusoidally oscillating shear stress. In the case of instruments operating with shear stress control, the deformation is measured as a function of time, and the time offset of this deformation is measured relative to the introduction of the shear stress. This time offset is referred to as the phase angle δ.

The storage module G′ is defined as follows: G′=(τ/γ)·cos(δ) (τ=shear stress, γ=deformation, δ=phase angle=phase shift between shear stress spectra and deformation vector). The deformation of the loss modulus G″ is as follows: G″=(τ/γ)·sin(δ) (τ=shear stress, γ=deformation, δ=phase angle=phase shift between shear stress vector and deformation vector).

A composition is considered in general to have touch-tack, and is defined in the sense of the invention as having touch-tack, if at room temperature, here by definition at 23° C., in the deformation frequency range from 10⁰ to 10¹ rad/sec, G′ lies at least partly in the range from 10³ to 10⁷ Pa, and if G″ likewise lies at least partly in this range. “Party” means that at least a section of the G′ curve lies within the window subtended by the deformation frequency range from 10⁰ inclusive up to 10¹ inclusive rad/sec (abscissa) and by the G′ value range from 10³ inclusive to 10⁷ inclusive Pa (ordinate). This is correspondingly applicable to G″.

PSAs are therefore permanently tacky at room temperature, thus having a sufficiently low viscosity and a high contact stickiness, so that they wet the surface of the respective bond substrate even with low applied pressure. The bondability of the PSAs derives from their adhesive properties, and the redetachability—depending on the inherent peel adhesion of the PSA—from their cohesive properties.

An adhesive bond in the context of the present invention is, for example and in particular, “partable” if the primer of the invention after activation thereof produces a lowering of the peel adhesion at 23° C. of at least 50%, preferably of at least 75%.

As pressure-sensitive adhesive for the primer it is possible to use all PSAs known to the skilled person, examples thus including those based on acrylates and/or methacrylates, polyurethanes, natural rubbers, synthetic rubbers, styrene block copolymer compositions with an elastomer block composed of unsaturated or hydrogenated polydiene blocks (polybutadiene, polyisoprene, copolymers of the two, and other elastomer blocks familiar to the skilled person), polyurethanes, fluoropolymers and/or silicones. The term also encompasses further compositions possessing touch-adhesive properties in accordance with the “Handbook of Pressure Sensitive Adhesive Technology” by Donatas Satas (Satas & Associates, Warwick 1999).

The pressure-sensitive of the primer is preferably based on acrylates.

Where acrylate-based pressure-sensitive adhesive are referred to in the context of this specification, the term embraces, even where not implicitly stated, pressure-sensitive adhesives based on methacrylates and based on acrylate and methacrylates, unless expressly described otherwise. Likewise in the sense of the invention are combinations and blends of two or more base polymers and also adhesives additized with tackifier resins, fillers, ageing inhibitors and crosslinkers, with the enumeration of the additives being merely illustrative and not limiting.

With particular preference the pressure-sensitive adhesive comprises a copolymer based on acrylic esters.

With very particular preference the pressure-sensitive adhesive is a copolymer of at least one acrylic ester with vinylcaprolactam.

With further preference the pressure-sensitive adhesive is free from acrylic acid.

The primer is expandable by the chemical or physical blowing agent. Expandable here means that the volume of the primer after the expansion is above that of the primer before the expansion, measured in each case at the same temperature (generally room temperature). The volume increase is preferably more than 5%, more preferably more than 20%. The expansion may take place chemically or physically. The adhesive preferably comprises a thermally activatable foaming agent.

The blowing agent is present in the composition of the primer preferably at a concentration of 10 wt % up to 120 wt %, based on 100 wt % of base polymer(s) present.

The blowing agent is preferably a particulate blowing agent. The median particle size (d50) before activation is preferably below 25 μm, especially preferably below 17 μm. With very particular preference the median particle size is below 3 μm, since a thin primer layer can therefore be achieved.

With further preference the particle size is above 500 nm, allowing a foaming effect to be achieved that is technically utilizable for detachment.

“Particles” of the blowing agent are understood in the sense of DIN 53206-1: 1972-08 to be primary particles, aggregates and agglomerates of the blowing agent. The “particle size” refers to the maximum extent of a particle. The particle size is determined preferably by means of laser scattering according to ISO 13320 (with agglomerates being dispersed in the dispersing step, but not aggregates), although other methods known to the skilled person are also suitable.

In the dried, unactivated primer layer, the blowing agent, more particularly the particulate blowing agent, is preferably present substantially in a plurality of—at least two—packed layers. The packing improves the expansion and therefore the separability of the bonded assembly.

With further preference the blowing agent, more particularly the particulate blowing agent, is present substantially in one layer in the dried, unactivated primer layer. The restriction to one layer allows the primer layer to be applied more thinly, so producing advantages in application (e.g. shorter flash-off times, less running) and in the primer effect.

“Substantially” means here that the respective arrangement of the particles is on more than 60% of the area coated with primer.

The primer preferably includes a rheological additive that reduces the sedimentation of a particulate blowing agent.

Preferred rheological additives are thixotropic agents, as sold for example by the company Erbslöh under the brand name Disparlon and by the company BYK under the brand name Tixogel, Rheobyk and BYK-GO.

The basic types of the chemical blowing agents can be divided according to their nature into organic and inorganic compounds. On the basis of their decomposition behaviour, a distinction is made between exothermic (1-5) and endothermic (6) blowing agents. In detail, the compounds in question are compounds, for example, from the following product classes:

1. Azo compounds:
preferably azodicarbonamide (ADC)

2. Hydrazine derivates:
preferably p-toluenesulfonyl hydrazide (TSH)
and p,p′-oxybis(benzenesulfonyl hydrazide) (OBSH)

3. Sulfonyl semicarbazides:
preferably p-toluenesulfonyl semicarbazide (TSSC)

4. Tetrazoles:
preferably 5-phenyltetrazole (5-PT)

5. N-nitroso compounds:
preferably N,N′-dinitrosopentamethylenetetramine (DNPT)

6. Carbonates:
preferably sodium hydrogencarbonate (NaHCO₃), zinc carbonate (ZnCO₃)

As physical blowing agents it is possible to use all of the physical blowing agents known to the skilled person.

The blowing agent is preferably a physical blowing agent;

preference is given to using expandable, thermoplastic microspheres (microballoons), more preferably thermally expandable, thermoplastic microspheres.

Expandable thermoplastic microspheres which comprise a thermoplastic polymer shell and a blowing agent enclosed therein are available commercially for example under the brand name Expancel®. In such microspheres the blowing agent is generally a liquid having a boiling point not higher than the softening temperature of the thermoplastic polymer casing.

The softening temperature of the polymer casing according to preferred embodiments is within the range from 0 to 140° C., most preferably from 30 to 100° C. On heating, the blowing agent evaporates and, in so doing, raises the internal pressure, and at the same time the shell softens, leading to a considerable enlargement of the microspheres. The temperature at which expansion commences is called Tₛₜₐᵣₜ, whereas the temperature at which maximum expansion is obtained is referred to as Tₘₐₓ. Tₛₜₐᵣₜ for the expandable microspheres is preferably from 40 to 140° C., most preferably from 50 to 100° C. Tₘₐₓ of the expandable microspheres is higher than Tₛₜₐᵣₜ and is preferably from 80 to 200° C., most preferably from 100 to 170° C.

According to preferred embodiments the blowing agent has an expansion temperature of 100 to 150° C.

According to particularly preferred embodiments the blowing agent has an expansion onset temperature of more than 130° C., since at higher softening temperatures of the polymer casing, a better durability of the dried primer has been ascertained.

According to further particularly preferred embodiments, the blowing agent has an expansion onset temperature of less than 130° C., since in this case the activation temperature is low.

The expansion temperature can generally be found in the data sheet from the suppliers. For expandable microspheres it is determined by means of thermomechanical analysis (TMA) at a heating rate of 20 K/min and a relative humidity of 50%. For chemical blowing agents the onset of a DSC at a heating rate of 20 K/min is used.

According to particularly preferred embodiments, the primer comprises microballoons which in the unexpanded state at 25° C. have a mean diameter of 3 μm to 30 μm, more particularly of 5 μm to 20 μm, and/or which after expansion have a mean diameter of 10 μm to 200 μm, more particularly of 15 μm to 90 μm. The mean diameter of the unexpanded microballoons is preferably below the layer thickness of the primer.

With further preference the blowing agent is a mixture of a physical and chemical blowing agent.

A further part of the invention is a layered structure comprising
a first component,
a primer layer which is on the component,
the primer being based on a pressure-sensitive adhesive, which comprises a chemical or physical blowing agent, and being applied from a liquid phase in a layer thickness (after drying) of not more than 30 μm,
an adhesive tape, more particularly pressure-sensitive adhesive tape, which is connected via the primer layer to the first component.

The primer layer may have a layer thickness in the customary range, in other words approximately 0.1 μm to 100 μm.

The primer preferably has a layer thickness of less than 25 μm, more preferably of less than 15 μm.

Very preferably the primer has a layer thickness of not more than 1 μm, more particularly a layer thickness of more than 5 μm in the dried state.

Very preferably the layer thickness of the primer is 1 to 10 μm, in order to keep the layer thickness low, and additionally 10 to 25 μm, in order to obtain a maximum expansion volume.

The primer is preferably applied in a coherent area (over the full area) on the component. The primer is applied preferably by means of a sponge or a pencil. More preferably the primer is applied using a guided metering nozzle, examples being “EV series automated dispensing systems” from Nordson EFD.

The adhesive tape may have a layer thickness in the customary range, in other words approximately from 2 μm to 2000 μm.

The adhesive tape preferably has a layer thickness of less than 300 μm, more preferably of less than 100 μm.

The adhesive tape preferably has a layer thickness of more than 30 μm, more preferably of more than 100 μm.

The ratio of the primer layer thickness to the thickness of the adhesive tape is preferably not more than 1:10, more particularly not more than 1:20.

The general expression “adhesive tape” in the sense of this invention embraces all sheet-like structures whose extent in two spatial directions (x-direction and y-direction; length and width) is substantially greater than in the third spatial direction (z-direction; thickness) such as films or film sections, tapes with extended length and limited width, tape sections, diecuts, labels and the like.

The adhesive tape may be made available in fixed lengths such as product by the metre, for example, or else as a continuous product on rolls (Archimedean spiral), i.e. disc-shaped rolls of adhesive tape, referred to in the language of the art as “pan-cakes”.

The adhesive tape may alternatively be coiled like a textile yarn onto a core, its length being substantially greater than the width of the adhesive tape. By the overlaying of a rotary movement of the core and an axial movement of the core or of the adhesive-tape guiding member, the adhesive tape initially forms a first, radially innermost ply of helical turns. To finish off the first ply and enter into the second ply, the orientation of the axial movement is inverted, with the rotary movement unchanged. To finish off the second ply and enter into the third ply, the orientation of the axial movement is again inverted, i.e. it reverts to the original orientation, while the rotary movement contains to be unchanged. The pitch angle remains constant between each of the orientation inversion points. In this way, numerous turn plies can be formed, their turns intersecting one another (cross-wound coils).

An “adhesive tape” embraces a carrier material which is provided on one or both sides with a (pressure-sensitive) adhesive and which may optionally have further layers in between.

More particularly, the expression “adhesive tape” in the sense of the present invention encompasses what are called “adhesive transfer tapes”, these being an adhesive tape without carrier. With an adhesive transfer tape, the adhesive is instead, before application, applied between flexible liners, which are provided with a release layer and/or which have anti-adhesive properties. For the application, generally speaking, a liner is first removed, the adhesive is applied, and then second liner is removed. The adhesive can be used accordingly to connect two surfaces directly. Carrierless adhesive transfer tapes of these kinds are particularly preferred in the invention. A tacky, carrierless adhesive transfer tape of this kind enables bonding which is very precise in terms of positioning and dosing.

The adhesive tape may be produced in the form of a roll, in other words in the form of an Archimedean spiral rolled up onto itself, or else lined on the adhesive side with release materials such as siliconized paper or siliconized film.

A suitable release material is preferably a non-linting material such as a polymeric film, or a well-sized, long-fibre paper.

According to a further preferred embodiment, the adhesive tape is embodied as an adhesive tape with an activatable adhesive.

Activatable adhesive used may in principle comprise all customary adhesive systems which exhibit activated bonding. The activation is accomplished in general via an input of energy, such as by actinic radiation, heat or mechanical energy, such as ultrasound or friction, for example.

Heat-activatedly bonding adhesives can be classed fundamentally into two categories: thermoplastic heat-activatedly bonding adhesives (hotmelt adhesives) and reactive heat-activatedly bonded adhesives (reactive adhesives). This classification also includes those adhesives which can be assigned to both categories, namely reactive thermoplastic heat-activatedly bonding adhesives (reactive hotmelt adhesives). Heat-activatedly bonding adhesives may be pressure-sensitively adhesive even at room temperature. The heat activation increases the bond strength.

Thermoplastic adhesives are based on polymers which on heating undergo reversible softening and which solidify again in the course of cooling. Thermoplastic adhesives which have emerged as being advantageous are, in particular, those based on polyolefins and on copolymers of polyolefins and also on acid-modified derivatives thereof, on ionomers, on thermoplastic polyurethanes, on polyamides and also polyesters and their copolymers, and also on block copolymers such as styrene block copolymers.

In contrast, reactive heat-activatedly bonding adhesives comprise reactive components. The latter constituents are also referred to as “reactive resins”, in which, by the heating procedure, a crosslinking process is initiated which, after ending of the crosslinking reaction, ensures a durable stable bond. Such adhesives preferably also comprise elastic components, for example synthetic nitrile rubbers or styrene block copolymers. Such elastic components give the heat-activatedly bonding adhesive a particularly high dimensional stability even under pressure, by virtue of their high flow viscosity.

Radiation-activated adhesives are based likewise on reactive components. The latter constitutes may comprise, for example, polymers or reactive resins in which the irradiation initiates a crosslinking process which, after ending of the crosslinking reaction, ensures a durable stable bond. Such adhesives preferably also comprise elastic components, of the kind set out above.

Radiation-activatable PSAs are to be distinguished from radiation-crosslinked PSAs, in which the properties of pressure-sensitive adhesiveness are established by means of radiation crosslinking during the production of the adhesive tape. With radiation-activatable PSAs, the radiative activation takes place on application. Following radiative activation, the adhesive is in general no longer tacky.

Activatable pressure-sensitive adhesive tapes also include pressure-sensitive adhesive tapes assembled from two or more films of adhesive, as disclosed in DE 10 2013 222739 A1. They are activated by the contacting of the two more films of adhesive.

According to one preferred embodiment of the invention there is a second component bonded on the free side of the adhesive tape.

With further preference there may be a further layer of primer of the invention applied between adhesive tape and second component.

A further part of the invention is a method for parting a layered structure comprising, preferably composed of,
a first component,
a primer layer which is applied on the component,
the primer being based on a pressure-sensitive adhesive, which comprises a chemical or physical blowing agent, and being applied from a liquid phase in a layer thickness (after drying) at not more than 30 μm,
a first adhesive tape, more particularly pressure-sensitive adhesive tape, which is connected via the primer layer to the first component,
the layered structure being heated until the blowing agent present in the primer expands, so that the peel adhesion of the primer layer is reduced to an extent such that the adhesive tape is removable from the component.

Removable here means that the peel adhesion of the assembly after heating of the layered structure is less than 40%, preferably less than 20%, more preferably less than 10% of the peel adhesion before the heating.

The layered structure may be heated by any form of heat supply whatsoever, as for example by convection (for example in an oven, with a hot-air blower) or by radiative heat (for example by an infrared lamp or laser radiation) or by heat conduction (for example on a hotplate) or by generation of heat in the layered structure (for example by induction, electrical current, chemical reaction or microwaves).

The thermal activation of the blowing agents may be accomplished by various technologies, in particular by contactless heating (for example induction or microwaves) or by electrical heating (Joule effect) or thermal heating (oven, hotplate, infrared lamp, tunnel, hot air, thermal decomposition).

Fillers used for the induction heating or microwave heating may in particular be the following: PEG, ferrites, carbonyl iron (high-purity iron powder).

For the heating by electrical conduction, the following fillers in particular may be used: silver-coated copper particles, silver-coated silicon dioxide particles, graphite, carbon black, carbon nanotubes, silver particles. These fillers may be used in order to endow the composition of the invention with sufficient conductivity to enable heating by the Joule effect under the action of the passage of an electrical current. These charges may also be used in order to allow the maintenance of the electrical conductivity within the assembly for the composition of the invention, as may be necessary for certain applications, in particular for the dissipation of electrostatic charges.

In order to improve the thermal conduction of the composition, the following fillers in particular may be used: graphite, metal fillers, boron nitride, aluminium oxide, aluminium hydroxide. This thermal conduction may be necessary in certain assemblies, for example in the case of the adhesive bonding of heating elements.

Following the thermal activation, detachment takes place preferably at room temperature, this being advantageous as it allows the materials (especially the carriers) to be handled more easily and without special equipment for the handling of hot surfaces. The detachment may take place manually or automatically.

Exposure to heat causes evaporation on the one hand of the liquid contained in the microballoons, while on the other hand the outer polymer casing softens. The capsules accordingly undergo irreversible extension and expand three-dimensionally. The expansion is at an end when the internal and external pressures match.

By the expansion of the microballoons or, generally, by the expansion of the blowing agent, adhesive tape and component are forced apart. At the same time there is a reduction in the peel adhesion developed by the primer with respect to the adhesive tape and/or to the component.

There are a great multiplicity of possible applications for the layered structure of the invention. One example is the disassembly of touch panels. In view of the major importance of mobile phones, this is a particularly important area of use. On the other hand, the desire is for very strong and also, in particular, sealing adhesive bonding of the displays of mobile phones. On the other hand it is frequently necessary for the display to be removed. The layered structure of the invention is especially suitable for this intended use.

A topic of increasing importance, lastly, is that of “reworkability”. In the automotive industry, for example, the requirements with regard to disposal of the products by individualized material at their end of their life cycle are increasing. It is therefore important that components which consist of different materials must be separated into the individual components again before they are disposed of, even if these components were joined to one another “inseparably” beforehand. The present invention enables a very strong and durable bond between different components and nevertheless allows these components to be separated on demand.

### Measurement Methods

The measurements are carried out—under expressly otherwise mentioned—under test conditions at 23±1° C. and 50±5% relative humidity.

### Peel Adhesions

The peel adhesions are determined in analogy to ISO 29862 (Method 3) at 23° C. and 50% relative humidity with a removal speed of 300 mm/min and a removal angle of 180°. The thickness of the primer layer here is 15 or 25 μm. An etched PET film with a thickness of 36 μm is used as a reinforcement film, and is of a kind obtainable from the company Coveme (Italy).

The substrate used comprises steel plates (50 mm×125 mm×1.1 mm) in accordance with the standard. The measurement strip (13 mm) is bonded here by means of a rolling machine at 4 kg with a temperature of 23° C. The time between the last over-rolling of the adhesive tape and the removal is 60 minutes.

The measurement value (in N/cm) was obtained as the mean value from three individual measurements. As well as the peel adhesive, the failure mode of the adhesive bond was ascertained.

### K Value

The K value is a measure of the average size of high-polymer molecules. For the measurement, one percent strength (1 g/100 ml) toluenic polymer solutions were prepared and their kinematic viscosities were determined by means of a Vogel-Ossag viscometer. Following standardization to the viscosity of toluene, the relative viscosity is obtained, and from this the K value can be computed by the method of Fikentscher (Polymer 8/1967, 381 ff.)

The invention is elucidated in more detail below by examples, without thereby wishing to limit the invention.

### EXAMPLES

Basis polymers for primers:
pressure-sensitive adhesive for primer (PSA 1)

The PSA copolymer contained in the primer in accordance with the invention was produced using the following raw materials:
70 wt % n-butyl acrylate (CAS: 141-32-2) and
30 wt % vinylcaprolactam (CAS: 2235-00-9)

The copolymer was prepared in a manner known to the skilled person by means of radical polymerization in a solvent mixture of ethyl acetate/isopropyl alcohol (168/1). The copolymer has a K value of about 84 and is adjusted to a solids content (SC) of 30 wt %.

In the peel adhesion test, coated in a thickness of 25 μm onto etched PET film (36 μm), the copolymer exhibits a peel adhesion of 2.5 N/cm. It is therefore a pressure-sensitive adhesive.

### Primer Polymer 2 for a Comparative Example

To produce the primer base of the comparative example, the thermoplastic copolyamide Platamid M 1276 (from Arkema) was dissolved in a solvent mixture of
60 wt % ethanol,
18 wt % isopropanol,
18 wt % methylcyclohexane and
4 wt % water

and adjusted to a solids content (SC) of 15 wt %.

### Primer Formulation

For the production of the primers of the invention, the base polymers described above in terms of their preparation and composition were used, along with the following raw materials, solvents and blowing agents:
Titanium tetraisopropoxide (Tyzor® TPT, Lehmann & Voß, CAS 546-68-9)
Isopropyl alcohol (CAS 67-63-0)
Microballoons from Matsumoto, type FN 100SSD
(size: 6 to 11 μm, Tₛₜₐᵣₜ: 120 to 130° C., Tₘₐₓ: 145 to 155° C.)
Microballoons from Matsumoto, type FN 100 SD
(size: 10 to 20 μm, Tₛₜₐᵣₜ: 125 to 135° C., Tₘₐₓ: 150 to 160° C.)

To produce the primers according to the invention, the primer PSA 1, in addition to the solvents contained in the primer PSAs, was additionally diluted with isopropyl alcohol to a solids content (SC) of 10 wt %.

In all of the examples the solids contents were chosen in each case so as to enable sufficient layer formation, allowing the corresponding comparative experiments to be conducted.

The raw materials/components specified in the examples were mixed using a magnetic stirrer from IKA® and a magnetic stirring bath for about 20 minutes.

### Example 1

### Primer Composition:

| Raw material/component | wt % |
|---|---|
| Solution of primer PSA 1 (SC 10.0 wt %) | 89.60 |
| Tyzor TPT | 0.40 |
| Matsumoto FN 100 SSD | 10.00 |

### Example 2

### Primer Composition:

| Raw material/component | wt % |
|---|---|
| Solution of primer 1 (SC 10.0 wt %) | 89.60 |
| Tyzor TPT | 0.40 |
| Matsumoto FN 100 SD | 10.00 |

### Primer Composition:

| Raw material/component | wt % |
|---|---|
| Solution of primer 1 (SC 10.0 wt %) | 97.10 |
| Tyzor TPT | 0.40 |
| Matsumoto FN 100 SD | 2.5 |

### Example 4 (Comparative Example)

### Composition of Comparative Primer:

| Raw material/component | wt % |
|---|---|
| Solution of primer polymer 2 (SC 15.0 wt %) | 90 |
| Matsumoto FN 100 SSD | 10 |

The specified solids contents of the respective polymers in solution can be used in each case for unambiguous determination of the weight fractions of microballoons relative to base polymers in the primer compositions.

### Producing the Test Specimens

A layer with the primer of the invention is produced in manner known to the skilled person, by first applying (using knife-coating technology) the primer in a defined layer thickness on a substrate (steel plate). Thereafter the solvent or solvents can be evaporated, after which the test adhesive tape can be applied to the substrate, which now bears the dried primer in a layer thickness of 15 or 25 μm, respectively. The time elapsing between application and evaporation of the solvent and the application of the test adhesive tape may be just a few minutes, or else several days or weeks.

The test adhesive tape with which the primers were tested is based on a polyacrylate PSA. The tape in question is the acrylate foam adhesive tape Tesa® 75120.

Tesa® 75120 is a double-sided black adhesive tape which consists of a black acrylate foam providing high-level impact damping.

The thickness is 200 μm.

The peel adhesion on steel (initial) is 13 N/cm; the peel adhesion polycarbonate (initial) is 10.9 N/cm.

### Activating the Blowing Agents

For the activation of the blowing agents, the test specimens were stored in an air circulation oven at 150° C. for 5 minutes. Activation of the blowing agents reduces the peel adhesion measured. After the thermal activation, the peel adhesion is measured at room temperature, preferably after a cooling time of 5 minutes.

Alternatively, if the substrate is a thermally conductive substrate, the blowing agents may also be activated by placing the test specimens on a precision hotplate (1 minute at 155° C.).

To characterize the specimens produced in accordance with the invention, peel adhesions were determined before and after activation in the air circulation heating oven. The results obtained in this determination were as follows:

| | Layer | Before | After activation |
|---|---|---|---|
| Primer | thickness | activation | (5 min, 150° C.) |
| Example 1 | 15 μm | 9.6 N/cm (A) | 0.4 N/cm (A) |
| Example 2 | 25 μm | 10.1 N/cm (A) | 0.6 N/cm (A) |
| Example 3 | 25 μm | 13.0 N/cm (A) | 2.4 N/cm (A) |
| Comparative | 15 μm | 9.0 N/cm (A) | 2.6 N/cm (A) |
| Example 4 | | | |
| None | — | 11.5 N/cm (A) | 13.2 N/cm (A) |

A = Adhesive detachment of the adhesive tape

Examples 1, 2 and 3 show clearly and unambiguously the effect of the primer of the invention in leading to a significantly greater reduction in the peel adhesion than the comparative primer, more particularly to a reduction of more than 75% in the peel adhesion.

1. A primer for producing a partable adhesive bond, the primer being based on a pressure-sensitive adhesive which comprises a chemical or physical blowing agent.

2. The primer according to claim 1, wherein the pressure-sensitive adhesive of the primer is based on acrylates.

3. The primer according to claim 1, wherein the pressure-sensitive adhesive of the primer comprises a copolymer based on acrylic esters, preferably a copolymer of at least one acrylic ester with vinylcaprolactam.

4. The primer according to claim 1, wherein the pressure-sensitive adhesive of the primer is free from acrylic acid.

5. The primer according to claim 1, wherein the blowing agent is a physical blowing agent.

6. A layered structure comprising
a first component,
a primer layer which is on the component,
the primer being based on a pressure-sensitive adhesive, which comprises a chemical or physical blowing agent, and being applied from a liquid phase in a layer thickness (after drying) of not more than 30 μm, and
an adhesive tape, which is connected via the primer layer to the first component.

7. The layered structure according to claim 6, wherein a second component is bonded on the free side of the adhesive tapes.

8. A method for parting a layered structure comprising,
a first component,
a primer layer which is applied on the component,
the primer being based on a pressure-sensitive adhesive, which comprises a chemical or physical blowing agent, and being applied from a liquid phase in a layer thickness (after drying) at not more than 30 μm,
a first adhesive tape, which is connected via the primer layer to the first component,
the layered structure being heated until the blowing agent present in the primer expands, so that the peel adhesion of the primer layer is reduced to an extent such that the adhesive tape is removable from the component.

9. A method of producing a component for a motor vehicle, which comprises incorporating the layered structure according to claim 6 into said component.

10. A method of producing an electronic device or component for an electronic device, which comprises incorporating the layered structure according to claim 6 into said electronic device.

11. The primer according to claim 5, wherein the physical blowing agent is thermally expandable, thermoplastic microspheres.

12. The layered structure according to claim 6, wherein the adhesive tape is a pressure-sensitive adhesive tape.

13. A component for a motor vehicle, which comprises the layered structure according to claim 6.

14. An electronic device, which comprises the layered structure according claim 6.

15. A component for an electronic device, which comprises the layered structure according claim 6.
